(19) United States
(12) Patent Application Publication
(10) Pub. No.: US 2026/0043497 A1
(43) Pub. Date: Feb. 12, 2026

(54) Multi-layer pipe and method of manufacturing a multi-layer pipe

(71) Applicant: Polyflow LLC, Midland, TX (US)

(72) Inventors: Malcolm Werner Kurt ROSENOW, Aiken, SC (US); Jing Yan CHEN, Houston, TX (US); Rafik BOUBENIDER, Cypress, TX (US)

(73) Assignee: Polyflow LLC, Midland, TX (US)

(21) Appl. No.: 18/797,942

(22) Filed: Aug. 8, 2024

(51) Int. Cl. F16L 9/18; F16L 9/12

(52) U.S. Cl. CPC F16L 9/18; F16L 9/121

(57) ABSTRACT

Multi-layer pipe and method of manufacturing a multi-layer pipe A multi-layer pipe comprising a pipe body extending between first and second ends of the pipe, the pipe body having a first pipe layer and a second pipe layer disposed about the first pipe layer. The pipe further comprising a vent strip intermediate the first and second pipe layers and extending between the first and second ends of the pipe, the vent strip comprising one or more fluid passageways extending the entire length of the vent strip.

### TECHNICAL FIELD

The invention relates to a multi-layer pipe. Particularly, though not exclusively, the invention relates to a multi-layer pipe for use as an onshore pipe for conveying oil and gas field fluids, for example in the form or a reinforced thermoplastic pipe. The invention also relates to a method of manufacturing such a pipe.

### BACKGROUND

Flexible composite pipe has been replacing steel in many applications with great success, including oil and gas pipelines, due to its versatility and durability. Flexible composite pipe is used in conveying oil and gas field fluids, such as water, gas (for example methane, ethane, CO₂) and hydrocarbon fluids, or other fluids such as hydrogen, and is typically used onshore or in shallow water applications (for example, less than 500 m water depth).

Reinforced thermoplastic pipe (RTP) is an example of a multi-layer flexible composite pipe reinforced by high-strength materials. RTP is suited to gas and oil transportation because of its ultra-low permeability and high strength, being capable of internal pressures exceeding 5,000 psi (˜34.5 MPa), and may be qualified and supplied in accordance with the American Petroleum Institute specification API 15S. RTP is corrosion-resistant and more durable than steel pipe: RTP can withstand salt corrosion, as well as H₂S/CO₂ corrosion, hence contributing to a longer lifespan when compared to steel pipe. Moreover, RTP can provide high flowrates due to a smooth inner surface and the inherent flexibility of the pipe, which removes the need for elbows.

RTP typically comprises at least one reinforcement layer to withstand internal pressure and/or tension in the pipe when in use. Such reinforcement layer may comprise long fibres, fibre strands, braids and the like, the filaments of which may be from one or more of steel, glass, carbon, aramid, basalt, or polyester, and which may also comprise a matrix material of a thermoplastic polymer. Fibres and/or strands or braids of fibres may be wound around the pipe in a helical manner, with lay angles optimised for pipe performance (the higher the angle the greater the pressure retainment capability, the lower the angle the greater the tension capability), or interwoven into a braid around the liner pipe. Multiple layers of reinforcement may be applied sequentially at different lay angles to optimise and provide torsional balance to the structure in manufacture and use, i.e., RTP may comprise one or more intermediate reinforcement layers.

RTP may further comprise an inner liner layer, and an outer protective sheath layer, each of which may be made of a polymer. The inner liner layer and/or the outer protective sheath layer may comprise a single layer and material, or a plurality of sub-layers co-extruded or co-axially extruded over each other with optional tie layers to ensure bonding between incompatible polymer layers. Polymers for RTP manufacture include MDPE, HDPE, XLPE, PE-RT, polyamides (for example PA-12, PA-11, PA-66, PA-6), thermoplastic elastomers, flexible polyvinyl chloride, acrylonitrile butadiene styrene (ABS), polyphenylene sulphide (PPS), though other polymers or polymer alloys may be used. RTP may comprise filled polymers where the polymer contains a portion of a filler material, such as fibres or particles.

RTP may be either of an unbonded construction, where the layers of the pipe are unbonded to each other, i.e., the inner fluid containing polymer liner layer is not bonded to the reinforcement layer, which is in turn not bonded to the outer protective sheath polymer layer, or of a bonded construction, i.e., all layers are bonded to each other as part of the pipe manufacturing resulting in a pipe which is in effect a single, consolidated layer comprising sub-layers. Unbonded RTP may be suitable for similar applications to bonded RTP, but is manufactured differently. In comparison with bonded RTP, unbonded RTP may be manufactured more quickly (as there is no need to bond or consolidate layers along the full length of the pipe, nor additional inspection to confirm such bonding is achieved), and is therefore more cost effective, and results in a pipe which is more flexible during handling and installation, being able to maintain and operate at a smaller bend radius without risk of damage to the pipe structure.

An end fitting, or coupling, provides a sealing transition between the pipe and a connecting component, and transmits normal service loads acting on the pipe without allowing the pipe to fail. End fittings may be used for connecting sections of RTP to one another or for connecting a section of RTP to, for example, terminal equipment. As such, RTP can be used, inter alia, to provide a flexible composite pipe assembly for transporting fluids from a well-head location to an export terminus, or to a refinery. In such a pipe assembly, a first section of RTP may be connected to one or more further sections of RTP. Each section of RTP may include at least one end fitting.

Problematically, the use of these multi-layer pipes in conveying oil and gas field fluids presents the issue of gas accumulation, which refers to the buildup of gases within the layers of composite piping. This buildup is problematic because it can cause operational problems, safety risks, and damage to infrastructure. A principal cause of gas accumulation is permeation. Permeation is the process through which gases like methane, hydrogen sulphide, and carbon dioxide, which are commonly found in oil and gas operations, permeate through certain materials, particularly plastic layers in the pipes. The gas molecules dissolve into the material and migrate through it, eventually accumulating at interfaces or within less permeable layers.

Accumulated gases can exert internal pressure on the pipe's structure, leading to delamination (separation of layers), formation of blisters, and eventual mechanical failure. These structural issues can drastically reduce a pipe's ability to handle operational stresses. Significant accumulations of gases, particularly flammable or explosive gases like methane, pose serious safety risks. For example, any sudden depressurisation (as might occur during maintenance or a breach) could lead to explosive decompression, where the rapid expansion of trapped gases causes violent ruptures or collapse of the pipe.

It is an object of embodiments of the invention to inhibit gas accumulation in multi-layer pipes, in particular RTP, and/or at least mitigate one or more problems associated with known arrangements.

### SUMMARY OF THE INVENTION

According to an aspect of the invention, there is provided a multi-layer pipe comprising: a pipe body extending between first and second ends of the pipe, the pipe body having a first pipe layer and a second pipe layer disposed about the first pipe layer; and a vent strip intermediate the first and second pipe layers and extending between the first and second ends of the pipe, for example from the first end to the second end, the vent strip comprising one or more fluid passageways extending the entire length of the vent strip. The vent strip is intended to allow gases that may otherwise accumulate between layers of the pipe to pass to either of the first and second ends of the pipe, or another predetermined location along a length of the pipe, where the gases can be expelled from the pipe body.

In certain embodiments, the vent strip may comprise a fabric or other textile material through which the one or more fluid passageways extend. Fabrics and other textile materials may be simple to incorporate, low cost means of providing the vent strip intermediate the first and second pipe layers. Fabrics and other textile means may provide flexible means of providing the vent strip, having fluid passageways therein as a result of their manufacturing processes, for example weaving.

In certain embodiments, the pipe may comprise an end fitting in which an end of the pipe body is mounted, the end fitting having a port to fluidly connect the vent strip to atmosphere. The end fitting may comprise a ferrule through which the port extends. Additionally, or alternatively, the port may comprise a valve, and wherein optionally the valve is a one-way valve. Fluidly connecting the vent strip to atmosphere via the end fitting may facilitate controlled release of accumulated gas.

In certain embodiments, the pipe may comprise an impervious strip, or cover strip, intermediate the second pipe layer and the vent layer. The impervious strip may seal the vent strip against the first pipe layer, for example by covering over the vent strip. The impervious strip may extend over edges of the vent strip to contact/seal against the first pipe layer, thereby providing a pocket in which the vent strip extends. The impervious strip inhibits fluid passing therethrough, thereby protecting the fluid passageways against ingress of polymer material which may be used during manufacture of the pipe body to form the second pipe layer over the first pipe layer and/or retaining gases in the vent strip and directing the gases along the length of the vent strip.

In certain embodiments, the fabric may be a woven or non-woven fabric. The fabric may be a unidirectional fabric. The fabric may be a non-crimp fabric. The fabric may comprise natural and/or synthetic fibres. The fabric may be a unidirectional textile reinforcement.

In certain embodiments, the first pipe may comprise one or more helically wrapped tapes, and optionally the helically wrapped tapes may comprise a plurality of metallic wires. Therefore, the first pipe layer may provide reinforcement layer to withstand internal pressure and/or tension in the pipe, as described above.

Additionally, or alternatively, the second pipe layer may be a polymer layer.

In certain embodiments, the pipe body may comprise a third pipe layer about which the first pipe layer is disposed, and optionally the third pipe layer is a polymer layer. The third pipe layer may provide an inner liner of the pipe, as described above.

In certain embodiments, the vent strip may be provided in the form of a tape extending longitudinally between the first and second ends of the pipe. Alternatively, the vent strip may be provided in the form of a tape extending helically between the first and second ends of the pipe. The vent strip may wholly cover the first pipe layer.

According to another aspect of the invention, there is provided a multi-layer pipe as described above used as an onshore pipe for conveying oil and gas field fluids, and wherein optionally the pipe is a reinforced thermoplastic pipe.

According to yet another aspect of the invention, there is provided a method of manufacturing a multi-layer pipe, the method comprising: providing a first pipe layer; applying a vent strip to an outer surface of the first pipe layer along a length thereof, the vent strip comprising one or more fluid passageways extending the entire length of the vent strip; and applying a second pipe layer over the first pipe layer to form a pipe body having the vent strip intermediate the first and second pipe layers.

In certain embodiments, the method may comprise applying an impervious strip, or cover strip, to cover the vent strip prior to applying the second pipe layer. Additionally, or alternatively, the applying the second pipe layer is by extruding the second pipe layer over the first pipe layer.

### BRIEF DESCRIPTION OF THE DRAWINGS

Embodiments of the invention will now be described, by way of example only, with reference to the accompanying figures, in which:

FIG. 1 is a perspective view of a multi-layer pipe according to an embodiment of the invention, the pipe comprise a vent strip;

FIG. 2 is a schematic view of a fabric from which may provide the vent strip of the pipe of FIG. 1; and

FIG. 3 is flow-chart of a method of manufacturing a multi-layer pipe according to an embodiment of the invention.

### DETAILED DESCRIPTION OF EMBODIMENTS OF THE INVENTION

Certain embodiments of the invention may have particular application as an onshore pipe, in particular a reinforced thermoplastic pipe (RTP), for conveying oil and gas field fluids. However, other applications are contemplated, for example shallow water applications. Generally, regardless of the application, embodiments of the invention may have application and/or use as a RTP.

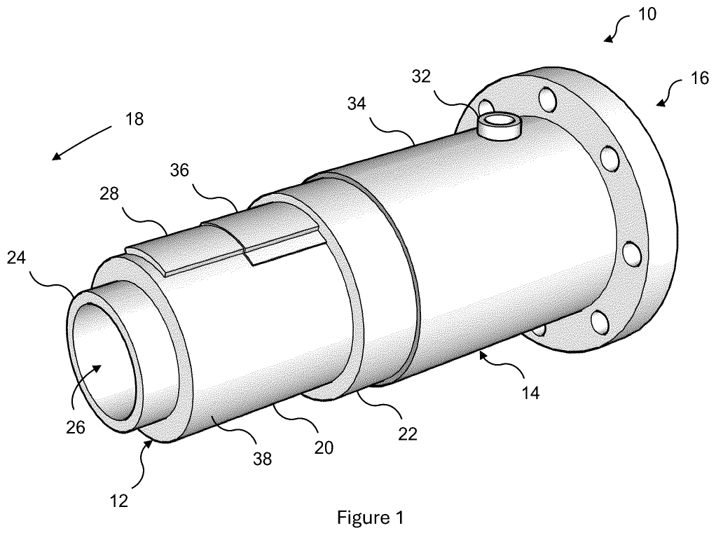

FIG. 1 shows a multi-layer pipe 10 according to an embodiment of the invention. The pipe 10 includes a pipe body 12 and an end fitting 14, in which the pipe body 12 is mounted. The pipe body 10 is a tubular structure extending between first and second ends 16, 18 of the pipe 10, and includes first and second pipe layers 20, 22. The second pipe layer 22 is disposed about the first pipe layer 20 such that the second pipe layer 22 is radially outward of the first pipe layer 20. As shown in the illustrated embodiment, the pipe body 12 may further comprise a third pipe layer 24, about which the first pipe layer 20 may be disposed. A bore 26 runs through the centre of the pipe body 12, which in the illustrated embodiment is delimited by the third pipe layer 24. The bore 26 allows for the passage of fluid through the pipe body 12, and hence through the pipe 10. The first pipe layer 20 may a be reinforcement layer. The second pipe layer 22 may be an outer protective sheath layer. The third pipe layer 24 may be inner liner layer. The reinforcement layer, the outer protective sheath layer, and the inner liner layer may each be as described above in the background section.

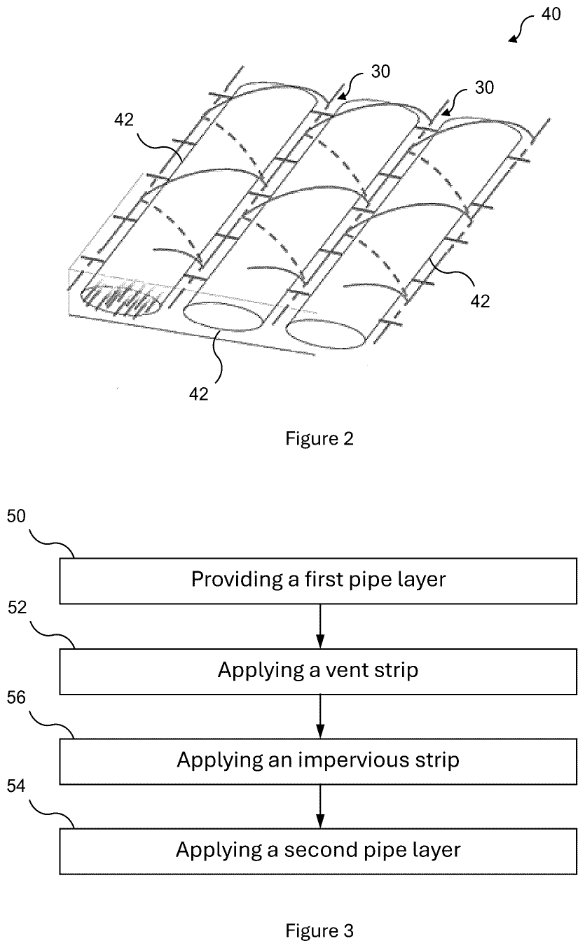

Intermediate the first and second pipe layers 20, 22, the pipe 10 comprises a strip of material 28, hereafter referred to as a vent strip. A shown in the illustrated embodiment, the vent strip 28 may overlay the first pipe layer 20, and may be affixed thereto. The purpose of the vent strip 28 is convey gas, which may diffuse out from the bore 26, through the first pipe layer 20, and build up in between the first and second pipe layers 20, 22 (or under the second pipe layer 22). The gas is conveyed along a length of the pipe body 12 to a desired location, for example at the end fitting 14, at which location the gas may be discharged from between the pipe layers 20, 22, as described in more detail below. To this end, the vent strip 28 comprises one or more fluid passageways 28 (shown in FIG. 2), through which the gas flows. The one or more fluid passageways 30 extend the entire length of the vent strip 28, i.e., from one end of the vent strip 28 to the other.

In the illustrated embodiment, the vent strip 28 extends longitudinally, or axially, along the entire length of the pipe body 12, though extends only partially about the circumference of the second pipe layer 22. In certain embodiments, the vent strip may extend over at least 10% of the circumference of the second pipe layer 22, i.e., by at least 36 degrees about the circumference. Additionally, or alternatively, the vent strip 28 may extend over no more than 25% of the circumference of the second pipe layer 22. While the one or more fluid passageways 30 necessarily extend the entire length of the vent strip 28, the vent strip 28 need not extend the entire length of the pipe body 12. In certain embodiments, the vent strip 28 may only extend along a length of the pipe body 12 to the desired location, and the desired location may be offset, or spaced apart, from the end of the pipe body 12 and/or the end fitting 14.

In certain embodiments, the pipe 10 may comprise one or more further vent strips (not shown). Therefore, while the vent strip 28 may extend continuously between the first and second ends 16, 18 of the pipe 10, the vent strip 28 together with one or more of the further vent strips may, alternatively, extend between the first and second ends 16, 18 of the pipe 10 by extending along respective longitudinal sections of the pipe body 12 and having overlapping or abutting ends. By virtue of the overlapping or abutting ends, the gas is able to flow along the entire length of the pipe body 12 by flowing from the fluid passageways 30 of the vent strip 28 to those of the one or more further vent strips. Additionally, or alternatively, the one or more vent further strips may extend continuously between the first and second ends 16, 18 of the pipe 10 and be offset circumferentially from the vent strip 28, e.g., a further vent strip may extend longitudinally along the entire length of the pipe body 12 diametrically opposite the vent strip 28.

The vent strip 28 may be provided in the form of a tape, and the tape may extend longitudinally between the first and second ends of the pipe 10, e.g., in any manner as described above. Alternatively, the tape may extend helically between the first and second ends of the pipe 10, the tape being wrapped about the circumference of the first pipe layer 20. Successive turns of the tape, as it wraps around the first pipe layer 20, may be spaced apart from one another. Alternatively, successive turns of the tape may abut or overlap one another.

FIG. 2 shows a fabric 40, which may provide the vent strip 28. In the illustrated embodiment, the fabric 40 comprises a single layer of fibre tows 42 extending in one direction only. The tows 42 are held in place by interwoven yarns in the warp (longitudinal) and weft (transverse) directions of the fabric 40. Spaces between adjacent tows 42 provide the fluid passageways 30. As such, it should be understood that the direction of the tows 42 is that of the longitudinal (axial) direction of the pipe body 12.

In the illustrated embodiment, the fabric 40 is a unidirectional, non-crimp fabric (NCF). NCFs are fabrics where the tows 42 are aligned in a straight, parallel orientation without any crimping or weaving. In additional to unidirectional NFCs, there is also multi-directional NCFs, which are composed of layers of unidirectional fibres oriented in multiple directions. These layers are stitched together without crimping the fibres. The fabric may 40 may be provided by a unidirectional NFC or a multi-directional NCF. Indeed, any suitable material may be used to provide the vent strip 28, i.e., any material capable of providing the one or more fluid passageways 30. Particularly suitable materials include fabrics and other textile materials.

In certain embodiments, the vent strip 28 may be provided by a unidirectional textile reinforcement, such as is available for use as reinforcement for composite materials, e.g., as used in the production of structural components such as rotor blades for wind turbines, aircraft wings, and boat hulls, where the textile reinforcement is impregnated with a resin during manufacture of the composite material. These materials are designed to have fluid passageways, as these are required to allow the resin to flow easily therethrough. Textile reinforcement is typically made from one or more of carbon, glass, aramid and natural fibres.

In certain embodiments, the vent strip 28 may be provided by a corrugated tape having corrugations in the vent strip 28 orientated around the circumference of the pipe 10, and the fluid passageways 30 are therefore provided down the length of the pipe 10 via individual corrugation channels running longitudinally down the pipe 10. The material of the corrugated tape may be porous to promote fluid to flow into the corrugation spaces, or may be perforated to allow free flow of fluid into the corrugation channels. Referring again to FIG. 1, the end fitting 14 enables the connection of the pipe 10 to other parts of a piping system, including other pipes, valves and/or process equipment. The end fitting 14 is intended to make a secure, leak-free connection to the pipe body 12. The end fitting 14 may be provided by any suitable fitting. While the illustrated embodiment comprises a flanged fitting, other suitable fittings include threaded fittings, quick-connect couplings and welded fittings. The end fitting 14 may be made from a high strength material, such as stainless steel or carbon steel, to withstand high pressures and corrosive environments. In order to provide the necessary connection to the pipe body 12, the end fitting 14 may comprise one or more compression rings (not shown). Opposing ends of the vent strip 28 may extend into respective end fittings at the opposing first and second ends of the pipe 10.

As shown in the illustrated embodiment, the end fitting 14 may comprise a port 32 to fluidly connect the vent strip 28 to atmosphere. The port 32 provide a fluidic connection of the fluid passageways 30 to atmosphere, by providing an opening the end fitting 14. In other words, the port 32 is fluidly connected, at least operably so, to the one or more fluid passageways and to atmosphere. The gas may therefore flow along the length of the pipe body 12, carried by the fluid passageways 30 within the vent strip 28, to be expelled from the pipe 10 via the end fitting 14. As the skilled reader will understand, flow of the gas through the pipe 10 is due to a pressure gradient, since gas diffusing from the bore 26 will be at a pressure higher than atmospheric pressure.

In the illustrated embodiment, the end fitting 14 comprises a ferrule 34 through which the port 32 extends. The port 32 may comprise valve, into order to control the flow of gas from the vent strip 28 and or prevent the flow of gas into the vent strip 28 through the port 32, i.e., the valve may be a one-way valve.

As shown in the illustrated embodiment, the pipe 10 may comprise a further strip of material 36, hereafter referred to as an impervious strip, intermediate the second pipe layer 22 and the vent layer 28. The purpose of the impervious strip 36 is to cover over the vent strip 28, thereby protecting the one or more fluid passageways 30 from ingress of material that cause blockage thereof, e.g., polymeric material during the forming of the pipe body 12. As such, the impervious strip 36 may alternatively be referred to as a cover strip. Also as shown in the illustrated embodiment, the impervious strip 36 may extend circumferentially about the pipe body 12 further than the vent strip 28, in order to fully encapsulate the vent strip 28 against the first pipe layer 20, i.e., the first pipe layer 20 and the impervious layer 36 together form a pocket, or sleeve-like structure. In such embodiments, the impervious layer 36 may be adhered, or otherwise attached, to the first pipe layer 20, along longitudinally extending edges, or along circumferential positions, of the impervious layer 36. In some embodiments the impervious layer 36 may cover the complete circumference of the pipe body 12 as an additional pipe body layer, covering multiple vent strips positioned at circumferential separations around the pipe body 12.

The impervious layer 36 may be formed of any suitable material. Suitable materials include a metallic foil, and a thin polymer tape, such as a polyethylene, polyamide, polyimide, PVDF, or a metallised polymer strip. The impervious layer 36 may include a suitable compatible adhesive, and/or comprise the same or similar material to the first pipe layer 20.

FIG. 3 shows a method of manufacturing the multi-layer pipe 10. The method comprises a first step 50 of providing or forming the first pipe layer 20, e.g., by braiding metallic wires into a tubular structure to provide the first pipe layer 20. In certain embodiments, wires may be interlaced at controlled angles to form a seamless reinforcement layer. Alternatively, the first pipe layer 20 may comprise one or more helically wrapped tapes, and the tape may comprises a plurality of metallic wires. Incorporating metallic wires into tapes to form the first pipe layer 20 may enhance tensile strength and pressure resistance the pipe body 12. The first step 50 may therefore comprise a process of embedding metallic wires within a polymer to form a composite tape. The composite tapes may then be wound helically, e.g., about the third polymer layer 24, in a specific pattern to achieve the desired layer.

The method comprises a second step 52, which occurs subsequent the first step 50, of applying the vent strip 28 to an outer surface 38 of the first pipe layer 20. The vent strip 28 may be adhered to the outer surface 38 by any suitable means, e.g., an adhesive. The vent strip 28 may be applied as a tape, and/or may be applied to extend longitudinally or helically in any manner as described above. The vent strip 28 is applied along a length of the first pipe layer 20, to extend between the first and second ends 16, 18 of the pipe 10. The application of the vent strip 28 may be such that vent strip 28 extends from the first end 16 to the second end 18, though may be otherwise such that vent strip 28 extends only along a length of the first pipe layer 20 between the first and second ends 16, 18 offset from one or both of the first and second end 16, 18.

The method comprises a third step 54, which occurs subsequent the second step 52, of applying the second pipe layer 22 over the first pipe layer 20. The application of the second pipe layer 22 is such that the pipe body 12 is formed having the vent strip 28 intermediate the first and second pipe layers, e.g., the second pipe layer 22 may be applied to the first pipe layer 20 by extruding the second pipe layer 22 over the first pipe layer 20. In such embodiments, an extrusion head may be used, which allows a molten outer layer material for forming the second pipe layer 22 to be extruded directly over the pre-formed inner pipe layer 20 having the vent strip 28 applied thereto.

In certain embodiments, the method may comprise a first additional step 56, which occurs subsequent the second step 50 and prior the third step 54, of applying the impervious strip 36 to cover the vent strip 28.

In certain embodiments, the method may comprise a second additional step of providing or forming the third pipe layer 24. The second additional step may comprise forming the third pipe layer 24 by an extrusion process, e.g., where polymer granules are melted and forced through an annular die to form a continuous pipe layer. The first pipe layer 20 may then be formed over the third pipe layer 24. The second additional step may occur prior the first step 50.

The invention is not restricted to the details of any of the above-described embodiments. For example, certain embodiments may also include one or more further pipe layers, including as described in the background section. Throughout the description and claims of this specification, the words “comprise”, “contain”, “having” and variations of them mean “including but not limited to”, and they are not intended to (and do not) exclude other moieties, components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, and characteristics, described in conjunction with a particular aspect, embodiment or example of the invention are to be understood to be applicable to any other aspect, embodiment or example described herein unless incompatible therewith. In particular, the phrase “certain embodiments” is to be understood to mean any embodiment described, illustrated, or otherwise disclosed herein. All of the features disclosed in this specification (including any accompanying claims, abstract and drawings), and/or all of the steps of any method or process so disclosed, may be combined in any combination, except combinations where at least some of such features and/or steps are mutually exclusive. The invention extends to any novel one, or any novel combination, of the features disclosed in this specification (including any accompanying claims, abstract and drawings), or to any novel one, or any novel combination, of the steps of any method or process so disclosed.

1. A multi-layer pipe comprising:
a pipe body extending between first and second ends of the pipe, the pipe body having a first pipe layer and a second pipe layer disposed about the first pipe layer; and
a vent strip intermediate the first and second pipe layers and extending between the first and second ends of the pipe, the vent strip comprising one or more fluid passageways extending the entire length of the vent strip.

2. A multi-layer pipe according to claim 1, wherein the vent strip comprises a fabric or other textile material through which the one or more fluid passageways extend.

3. A multi-layer pipe according to claim 1, wherein the pipe comprises an end fitting in which an end of the pipe body is mounted, the end fitting having a port to fluidly connect the vent strip to atmosphere.

4. A multi-layer pipe according to claim 3, wherein the end fitting comprises a ferrule through which the port extends.

5. A multi-layer pipe according to claim 3, wherein the port comprises a valve, and wherein optionally the valve is a one-way valve.

6. A multi-layer pipe according to claim 1, wherein the pipe comprises an impervious strip intermediate the second pipe layer and the vent layer.

7. A multi-layer pipe according to claim 2, wherein the fabric is a woven or non-woven fabric.

8. A multi-layer pipe according to claim 2, wherein the fabric is a unidirectional fabric.

9. A multi-layer pipe according to claim 2, wherein the fabric is a non-crimp fabric.

10. A multi-layer pipe according to claim 1, wherein the fabric comprises natural and/or synthetic fibres.

11. A multi-layer pipe according to claim 1, wherein the first pipe comprises one or more helically wrapped tapes.

12. A multi-layer pipe according to claim 11, wherein each of the helically wrapped tapes comprises a plurality of metallic wires.

13. A multi-layer pipe according to claim 1, wherein the second pipe layer is a polymer layer.

14. A multi-layer pipe according to claim 1, wherein the pipe body comprises a third pipe layer about which the first pipe layer is disposed, and optionally the third pipe layer is a polymer layer.

15. A multi-layer pipe according to claim 1, wherein the vent strip is provided in the form of a tape extending longitudinally between the first and second ends of the pipe.

16. A multi-layer pipe according to claim 1, wherein the vent strip is provided in the form of a tape extending helically between the first and second ends of the pipe.

17. The use of a multi-layer pipe according to claim 1 as an onshore pipe for conveying oil and gas field fluids, and wherein optionally the pipe is a reinforced thermoplastic pipe.

18. A method of manufacturing a multi-layer pipe, the method comprising:
providing a first pipe layer;
applying a vent strip to an outer surface of the first pipe layer along a length thereof, the vent strip comprising one or more fluid passageways extending the entire length of the vent strip; and
applying a second pipe layer over the first pipe layer to form a pipe body having the vent strip intermediate the first and second pipe layers.

19. A method according to claim 18, wherein the method comprises applying an impervious strip to cover the vent strip prior to applying the second pipe layer.

20. A method according to claim 18, wherein the applying the second pipe layer is by extruding the second pipe layer over the first pipe layer.
